(19) United States
(12) Patent Application Publication
(10) Pub. No.: US 2021/0390403 A1
(43) Pub. Date: Dec. 16, 2021

(54) METHOD AND DEVICE FOR CORRECTING ERRONEOUS NEURON FUNCTIONS IN A NEURAL NETWORK

(71) Applicant: Robert Bosch GmbH, Stuttgart (DE)

(72) Inventors: Andre Guntoro, Weil Der Stadt (DE); Christoph Schorn, Leonberg (DE); Jo Pletinckx, Sersheim (DE); Leonardo Luiz Ecco, Stuttgart (DE); Sebastian Vogel, Schaidt (DE)

(21) Appl. No.: 17/328,761

(22) Filed: May 24, 2021

(30) Foreign Application Priority Data
Jun. 12, 2020 (DE) 102020207320.1

(51) Int. Cl. G06N 3/08; G06N 3/04

(52) U.S. Cl. CPC G06N 3/08; G06N 3/04

(57) ABSTRACT

A computer-implemented method for calculating an output value of a neural network including multiple neurons as a function of neuron output values. The method includes: checking neuron functions of one or of multiple neurons of a neuron group; when establishing an error in the neuron group, determining a criticality of the error; correcting the neuron output values of at least one of the one or of the multiple neurons of the neuron group as a function of the criticality of an established error.

### CROSS REFERENCE

The present application claims the benefit under 35 U.S.C. § 119 of German Patent Application No. DE 102020207320.1 filed on Jun. 12, 2020, which is expressly incorporated herein by reference in its entirety.

### FIELD

The present invention relates to neural networks and, in particular, to measures for checking and correcting functions of neurons in neural networks.

### BACKGROUND INFORMATION

Machine learning methods are used increasingly in order to manage complex tasks in various fields. Adaptive systems are suitable, in particular, for tasks such as, for example, classification of images, object identification, language processing and more. The possibility of providing highly parallel processing units on a single component enables deep neural networks to be implemented with a high degree of parallelism.

In a highly integrated implementation of deep neural networks, in particular, hardware errors that affect one or multiple individual neurons become more likely. There is therefore a basic need for identifying functional errors.

A form of redundancy is necessary for error identification and, if necessary, error correction. The manner in which the redundancy is utilized in order to identify and, if necessary correct errors is generally problem-specific. A combination of different forms of redundancy is frequently also applied on multiple levels of the entire system. The redundancies may, in principle, encompass spatial redundancy (proliferation of structures), temporal redundancy (time-delayed expiring check) and coding (redundancy in the form of multiple pieces of information having the same informational content).

The conventional approaches to providing redundancy may also be used in the field of deep neural networks. This encompasses, for example, the replication of parts of the neural network and the like. It may be said, however, that many of the known approaches for deep neural networks are useful only to an unsatisfactory degree. The conventional approaches of providing redundancy for deep neural networks, in particular, intervene in the architecture of deep neural network or change the training method thereof or require a dedicated hardware or modification of the hardware, which is not provided in the standard components.

### SUMMARY

According to the present invention, a method is provided for correcting a neuron function of a neural network, as well as a neural network.

Further embodiments of the present invention are described herein.

According to one aspect of the present invention, a method is provided for calculating an output value of a neural network including multiple neurons. In accordance with an example embodiment of the present invention, the method includes the following steps:
checking neuron functions of one or of multiple neurons of a neuron group;
when establishing an error in the neuron group, determining a criticality of the error;
correcting the neuron output values of at least one of the one or of the multiple neurons of the neuron group as a function of the criticality of an established error.

The conventional check sum method from the related art provides for ascertaining erroneous neuron calculations by a check sum comparison. Erroneous neurons of a neuron group thus identified may be corrected accordingly with the aid of a comparison calculation. For this purpose, a sum of neuron outputs of multiple neurons of the neuron group is generally calculated and this sum is compared with a check sum. An error is present if the difference of the two values is not equal to zero. The check sum may be ascertained in this case from the sum of neuron input values, which are weighted with weighting factors that result in each case from the sum of the weights of the neuron group belonging to the input values. If bias values are present, the sum of the bias values of the neuron group must also be added to the check sum.

The localization of errors in neurons is, in the simplest case, limited to only one neuron group of multiple neuron groups, which represents a subset of all neurons. Using multiple check sum calculations, however, it is possible to achieve a more precise localization up to and including the localization of individual erroneous neurons. The more exact localization is, however, associated with a more time-consuming calculation of the check sums, so that the time of an inference of the neural network potentially increases.

For identified calculation errors, corrections may be provided, which replace an erroneous neuron output value in a suitable manner.

Depending on the implementation of the check sum method and the number of calculation errors occurring and identified during an inference of the neural network, the correction calculations in the previously described method may significantly delay the final output of the neural network. This may, for example, be due to the fact that an implementation of the check sum method necessitates a large number of computing steps or memory accesses for the error correction. This is the case, in particular, if no exact localization of the error or of the errors in the neural network is possible. Moreover, many or multiple correction calculations are necessary in the case of a large number of errors occurring simultaneously or in succession.

In many of the possible cases of error within a neural network, an error correction is unnecessary, however, if a non-critical error is involved. Non-critical errors refer to errors that do not change or change only insignificantly the final output value. When using neural networks for processing sensor signals in embedded system, for example, usually only the final output of the neural network for a given input signal is of importance, which may strongly or weakly depend on a result of a neuron calculation.

The inherent error resilience of typical neural networks, in particular, also of deeper neural networks, for the pattern identification in sensor data, also results in a multitude of the possible error contents of the calculation path being non-critical. On the one hand, the error propagation into deeper layers of the neural network may be prevented by activation functions or pooling functions, on the other hand, a certain information redundancy as a result of the parallel information processing is provided by the multitude of neurons in the individual layers of the neural network. The failure of a neuron function of an individual neuron is negligible, in particular, in layers in which the number of neurons is very high.

A method in accordance with an example embodiment of the present invention therefore provides for performing the correction of the error of the neuron calculation as a function of the criticality of the error. In the case of a high criticality, an exact error correction may, in particular, be carried out, which requires a high degree of computing effort, and in the case of low criticality, an approximate error correction may be carried out, which may be implemented with less computer effort. This may improve the efficiency and functional reliability of an error correction, since many correction calculations and the corresponding delay time for carrying out the error corrections may be saved. In real-time applications, in particular, a reduced delay of the inference by a neural network may contribute to the improvement of the functional reliability.

The criticality of the error in an error assessment may also be detected by determining an error with the aid of a check sum comparison, the check sum deviation between the sum of the neuron output values and a check sum of a criticality of the error being assigned with the aid of an error assessment function.

An error may, in particular, be assessed as critical if the check sum deviation is greater than a predefined threshold value.

The predefined threshold value may further be established individually or identically for all neuron groups of a layer of neurons or identically for all neuron groups.

In accordance with an example embodiment of the present invention, it may be provided that the criticality of the error is identified in an error assessment by determining an error with the aid of a check sum comparison, the criticality of the established error being determined with the aid of an error assessment function as a function of a check sum deviation between the sum of neuron output values and a check sum, the error, in particular, being identified as non-critical if the neuron output value is smaller than the check sum deviation.

Alternatively or in addition, the criticality of errors in an error assessment may be determined as a function of the number of errors of a layer found or of an area of the neural network.

Alternatively or in addition, the criticality of an error in an error assessment may be determined as a function of the position of the checked neuron group in which an error is established.

Alternatively or in addition, the criticality of an error may be determined with the aid of a data-based, trainable error relevance model, which is trained to specify the criticality of the error as a function of error characteristics, in particular, for different neuron groups of neurons, the check sum deviations and/or the position of the checked neuron groups within the neural network in which the erroneous calculation has occurred.

When establishing a critical error, an error correction may further be carried out, in which the neuron output values of neurons of the checked neuron group are replaced by error correction values. When establishing a non-critical error, a simplified error correction may, in particular, be carried out, in which the neuron output values of neurons of the checked neuron group are replaced by approximate, easier to calculate error correction values.

When establishing a non-critical error, an error correction may, in particular, be carried out, in which the neuron output values of neurons of the checked neuron group in which an error has been established, are set to zero or are determined, in particular, by interpolation, as a function of neuron output values of adjacent neurons belonging to a neuron group, in which no error is established.

When establishing a non-critical error, an error correction may further be carried out, in which the error correction values of the neurons of the neuron group identified as erroneous or of one or of multiple neurons determined to be erroneous, are predicted with the aid of a trainable, data-based error correction model, which is trained to provide suitable error correction values as a function of neuron output values of adjacent neurons.

It may be provided that when establishing a non-critical error, no error correction is carried out.

According to one further aspect of the present invention, a device for calculating an output value of a neural network of multiple neurons is provided. In accordance with an example embodiment of the present invention, the device is designed to carry out the following steps:
checking neuron functions of one or of multiple neurons of a neuron group;
when establishing an error in the neuron group, determining a criticality of the error;
correcting the neuron output values of at least one of the one or of the multiple neurons of the neuron group as a function of the criticality of an established error.

### BRIEF DESCRIPTION OF THE DRAWINGS

Specific embodiments of the present invention are explained in greater detail below with reference to the figures.

FIG. 1 schematically shows a representation of a neuron.

FIG. 2 schematically shows a representation of a functional diagram for illustrating the functionality of a control neuron.

FIG. 3 shows a flowchart for illustrating a method for the selective error correction of neuron functions in a neural network, in accordance with an example embodiment of the present invention.

### DETAILED DESCRIPTION OF EXAMPLE EMBODIMENTS

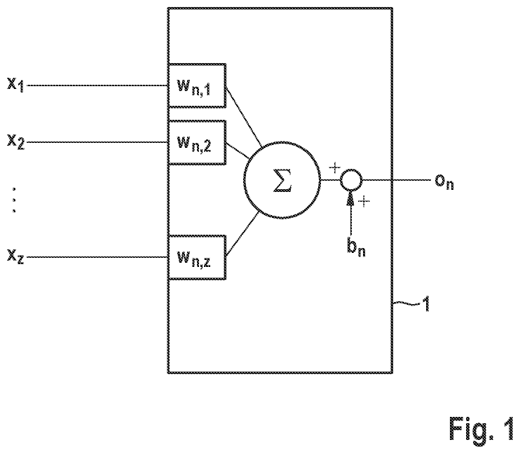

The core process of neural networks is in the neuron function. A neuron 1 for constructing a neural network is schematically represented in FIG. 1. Neuron 1 carries out the neuron function, which encompasses an addition of a sum of input values xᵢ weighted with weightings w_{n,i} to a bias value bₙ, in order to generate a neuron output value:

$${o}_{n} = {\sum }_{i = 1}^{z} {x}_{i} {w}_{n , i} + {b}_{n}$$

z corresponds to the number of neuron inputs. The application with bias value bₙ may, if necessary, be optional. Weightings w_{n,i} and bias values bₙ represent the parameters of the neuron function.

An activation function is applied, if necessary, to the neuron output value in order to obtain a neuron output. The activation function is handled separately in hardware implementations and is not further considered herein.

Thus, each neuron 1 is defined by a number of weighting values w_{n,i} assigned to neuron 1 and to the respective neuron inputs and by an assigned bias value bₙ. Neurons including such a neuron function are generally implemented by a multitude of multiply-accumulate elements (MAC) in an integrated manner.

To check the functional capability of neurons, specific embodiments are described below, which utilize the associative law of mathematics, according to which the sum of the neuron output values of the considered neurons, the sum of the products of each neuron input corresponds to the sum of the weighting assigned to the neuron plus the sum of the bias value. The following applies:

$${\sum }_{n = 1}^{m} ( {\sum }_{i = 1}^{Z} {x}_{i} {w}_{n , i} + {b}_{n} ) = {\sum }_{i = 1}^{z} ( {x}_{i} {\sum }_{n = 1}^{m} {w}_{n , i} ) + {\sum }_{n = 1}^{m} {b}_{n}$$

where m>1 of the number of neurons to be checked. The right portion of this equation may be implemented by a control neuron 2.

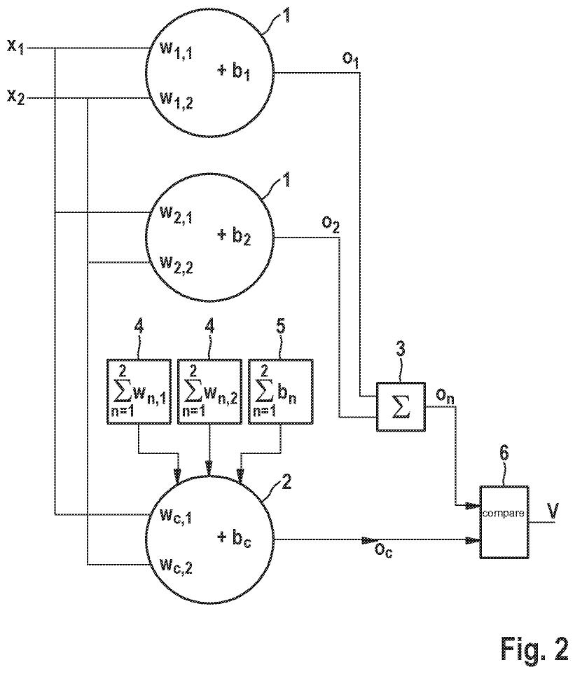

A functional diagram for implementing such a control neuron 2 for two neurons 1 to be checked of a neuron group is schematically depicted in FIG. 2. In this diagram, two neuron inputs x₁, x₂ are fed in each case to neurons 1 to be checked, where they are multiplied by a respectively assigned weighting w_{1,1}, w_{1,2}, w_{2,1}, w_{2,2} and additively applied with a bias value b₁, b₂. The respective neuron output value o₁, o₂ is fed to a summing element 3 in order to obtain a first comparison value oₙ.

Furthermore, the sum of weightings Σₙ₌₁²w_{n,1}, Σₙ₌₁²w_{n,2} assigned to a respective neuron input, applied to the respective neuron input x₁, x₂, are calculated in second summing elements 4 and fed to control neuron 2 as control neuron weightings w_{c,1}, w_{c,2}. Alternatively, since the weightings are fixed after the training, the sum of the weightings may be calculated in advance and accordingly provided from a suitable memory.

Furthermore, the sums of the bias values b₁, b₂ assigned to a respective neuron input, which are applied to the respective neuron input x₁, x₂, are calculated in a third summing element 5 and fed to control neuron 2 as control neuron bias value b_{c}. Alternatively, since the bias values b₁, b₂ are fixed after the training, the sum of the weightings may be calculated in advance and accordingly provided from a suitable memory.

The sum of the products from control weightings w_{c,1}, w_{c,2} in control neuron 2 is calculated with the respectively assigned neuron inputs and additively applied to a control neuron bias value b_{c} in order to obtain a second comparison value o_{c}.

First comparison value oₙ and second comparison value o_{c} are fed in a comparison block 6 in order to obtain a comparison result V. In the case of identical comparison results, no error is established and in the case of non-identical comparison results V, an error is established. In this way, errors in the calculation of a neuron output value may be found, the cause of the error possibly being in the calculation hardware of a neuron or in the memories for storing the neuron parameters, such as weightings and bias value. In this way, a control neuron 2 may be used in order to identify an error of one of the calculations of neurons 1.

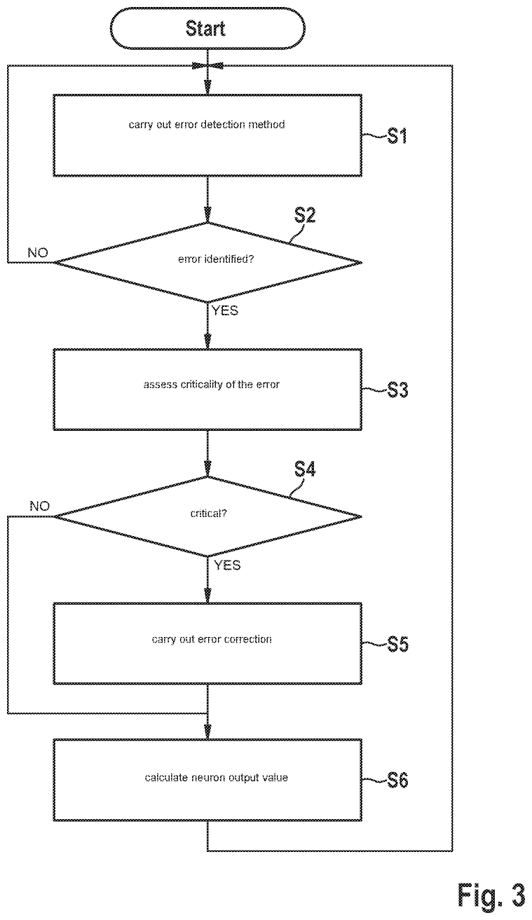

The method for illustrating a selective error correction is explained in greater detail in connection with FIG. 3. This method may be provided by an algorithm implemented as software or as hardware and may be carried out in a control unit.

In step S1, an error detection method such as, for example, a check sum comparison is carried out corresponding to the approach as it has been described in connection with FIG. 2. The error detection method identifies an error in the calculation of one or of multiple neuron output values of neurons in a neuron group of multiple neurons.

In step S2, it is checked whether an error has been identified. If this is the case (alternative: yes), the method is continued with step S3, otherwise (alternative: no) the method is continued with step S1. An error is identified if a deviation is present between the neuron output values and the neuron output values to be expected. For example, a function check is carried out using the above described method of the check sum comparison, in which the sum of neuron output values of neurons of one neuron group is compared with a check sum. The check sum results from a sum of all neuron input values weighted with all assigned input weightings of each of the neuron input values.

An error assessment is carried out in step S3. The error assessment assesses the criticality of the error based on various criteria.

The criticality is then checked in step S4 and the method is continued with step S5 if the error is critical (alternative: yes), otherwise (alternative: no) the method is continued with step S6.

Thus, a check sum deviation 5 may be evaluated with the aid of a threshold-based method. Check sum deviation 5 corresponds to oₙ-o_{c}. In this case, it is assumed that in the neuron group monitored by the respective check sum, only one single neuron is erroneous and an erroneous calculation of comparison value o_{c} is given. Then δ corresponds to the deviation of the erroneous neuron output value oₙ from the correct, i.e., from the second comparison value o_{c}.

It has been experimentally shown that high positive deviations of the result of a neuron function in typical neural networks, i.e., the erroneous neuron output value is much higher than the correct neuron output value, with a Rectified Linear Unit (ReLU) activation function, are more critical than small or negative deviations. This results in a threshold-based error assessment function

$$f ( δ ) = \{ \begin{matrix}critical if δ > 0 \\ non \text{-} critical else\end{matrix} .$$

the criticality of the error being able, for example, to be assumed as 1 for a critical error and as 0 for a non-critical error.

Threshold value θ for the selected neuron group of neurons to be checked may be established in each case individually for each neuron group. A uniform threshold value may, however, also be established in each case per layer of the neural network. The determination of suitable threshold values θ may, for example, take place with the aid of error injections or by considering the standard deviation of the neuron functions for a given set of input data of the neural network.

In the case of error injection, the neuron output values of a layer are artificially applied (for example, by simulation) with errors. In this case, errors having the amount “e” are added in each case to the neuron output values in multiple iterations at randomly selected neurons of the layer. The error amount “e” is varied over the iterations and for each selected error amount, the average rate of change of the output values in the last layer of the neural network is determined for a suitable set of sample data, which are applied to the input layer of the neural network.

The rate of change in classification networks may be defined, for example, as the proportion of data having a differently predicted object class as compared to the error-free case. A maximum tolerable rate of change is established. The maximum error amount “e_max” may subsequently be determined from the set of experiments, for which the limit of the tolerable rate of change has not been exceeded and the threshold value is set equal to “e_max”.

When considering the standard deviation, multiple suitable sample data (training data set) are applied at the input of the neural network and a forward-propagation through the network is calculated for each of the training data sets. In this way, the corresponding neuron output values are obtained for each datum.

When considering the neuron output values of a layer for the set of sample data, it is possible to calculate the empirical standard deviation from the neuron output values using established statistical methods. This deviation may, for example, be weighted using a suitable factor in order to establish the uniform threshold value for the layer.

In a sign-based method, errors of the neuron function are considered to be non-critical if the results of the neuron function of a neuron group to be checked are negative both with and without deviation, since the error is then masked by the normally used ReLu activation function. The error assessment function used may therefore be:

$$f ( δ ) = \{ \begin{matrix}critical if & ( {o}_{n} < 0 ) ⩓ ( {o}_{n} < δ ) ∀ n ∈ N \\ non \text{-} critical & otherwise\end{matrix} .$$

where oₙ corresponds to the error-containing value of the neuron function before applying the activation function. The criticality of the error may thus be ascertained with the aid of the above error assessment function. This method is computationally less intensive, since the two comparisons and the logical AND-connection are able to be calculated with little effort.

In a counter-based method, the number of errors found is used as decision criterion for the assessment of the criticality of the errors. This is based on the assumption that the likelihood of the output of the neuronal network changing as a result of errors in neurons of the intermediate layers increases with the number of errors. For this purpose, the errors per layer of the neural network may be counted for the instantaneous calculation.

If the number of errors in a layer of the neural network is above a fixed value, the error is considered to be critical, otherwise non-critical. The threshold value may, for example, be established as a percentage in relation to the number of neurons of the respective layer of the neural network. If multiple neuron groups for a layer of the neural network are tested using a function test, the number of the erroneous neuron groups found may be assumed to be an indication of the criticality of the errors. If the number of errors exceeds a predefined threshold number, then the presence of a critical error may be assumed.

One further possibility for applying this method may result in the case of sequential input data such as, for example, of an image sequence, of a video camera. Accordingly, the number of erroneous calculations within a time window may be used as a decision criterion. If, for example, an error for the instantaneous video frame has been identified and at least one further error contained errors within a number of preceding video frames, then, the instantaneous error may be identified as critical.

In an alternative position-based assessment method, it may be decided based on the position of the error within the neural network whether the error in each case is critical or non-critical. For this purpose, the neurons of the neural network are subdivided into areas, for which it is specified whether errors occurring therein are critical or non-critical or their criticality is specified. Errors that are established for neuron calculations in neuron groups in non-critical areas are therefore classified as non-critical, and errors that are established for neuron calculations in neuron groups in critical areas are classified as critical. The areas are established in advance by initially determining for each area the expected influence of errors on the output of the neural network. Neuron groups of neurons in which the average influence of errors on the output value falls below an established threshold value are defined as non-critical, and vice versa.

The influence of errors on the output of the network may be predicted by error injection experiments or by analytical neuron relevance assessment methods. One result of this analysis may, for example, be that errors in neuron layers including numerous neurons are non-critical, whereas errors in neurons in layers including few neurons are critical. If an error then occurs during operation of the neural network, it is initially ascertained whether this error is in a critical area of the neural network. If this is the case, the error is assessed as critical, otherwise as non-critical.

With the aid of a machine learning method, it is possible using a data-based, trainable error relevance model to calculate corresponding error characteristics, in particular, for different neuron groups of neurons, the check sum deviations and the localization of the checked neuron group within the neural network in which the erroneous calculation has occurred, the criticality of the error. If necessary, the prediction may be improved by further inputs into the error relevance model, for example, the neuron output values of the neurons of the neuron groups of the neurons. The training of the error relevance model takes place with the aid of simulated errors in the calculations of the neural network to be checked on a representative data set. For each simulated error in this case, it is ascertained whether the error is critical or non-critical. This information is then used to specify the output value as a training datum for the training of the error relevance model. The error relevance model may be designed in the form of a Gaussian process model, of a deep neural network or the like.

The above described methods for error assessment may be jointly applied individually or in arbitrary combinations. This means, the error assessment methods may be carried out in parallel and, at a predefined number of errors that are considered to be critical, a corresponding error correction may be carried out.

If the error is identified as critical, i.e., the criticality of the error exceeds a predefined criticality threshold value, an error correction is then carried out in step S5. The erroneous neuron output values are replaced during the error correction by corrected values.

In step S6, the neuron output value of the neural network is further calculated using the error-free, error-containing and/or corrected neuron output values.

Thus, it may be provided that when establishing an error in a neuron group, the neurons of the checked neuron group remain disregarded, i.e., the neuron output values of all neurons of this neuron group are set to zero. If an error is established in one neuron group of neurons, all neurons contained therein are thus deactivated. It is assumed in this case that neural networks usually exhibit a high robustness against the shutting down of individual neurons.

One further possibility is to correct the corrected neuron output values for erroneous neurons in a neuron group of the neurons by considering the respectively adjacent neuron output values. This possibility is appropriate, in particular in the case of convolution-based neural networks, since here values of adjacent neurons along the axes in which the convolution operation is carried out exhibit a certain correlation.

In the case of non-critical errors, for example, the value of a particular adjacent neuron may in each case be adopted for correction or an interpolation based on multiple adjacent neurons may be calculated. To handle critical errors, the exact correction value is ascertained, for example, via a complete recalculation of all neuron output values of the error-containing neuron group, or via the calculation of one or of multiple further check sums for ascertaining the exact correction value according to the “principle of exclusion”. In contrast, the interpolation method for ascertaining an approximate correction value for handling non-critical errors is significantly less time-consuming.

Moreover, the error correction values of the neurons of the neuron group checked as erroneous or of one or of multiple neurons determined to be erroneous, may be predicted with the aid of a trainable, data-based error correction model. The error correction model may, for example, be designed as a Gaussian process model or a further neural network, which provides correction values for the neurons of the checked neuron group of neurons. The training of the error correction model takes place via error simulation in the monitored neural network, the actual corrected values being ascertained for each simulated error and being used as corrected neuron output value for the error-containing neuron or neurons.

One particular combination is represented by the position-based error assessment method including the non-correction of non-critical errors. Since the critical and non-critical areas are fixed in each case before the calculation, the error check for the non-critical areas of the neural network may be omitted in this case. For example, the processing unit for the check sum calculation during the calculation of non-critical layers of the neural network may be deactivated in order to save power and calculation time.

Example embodiments of the present invention are also set forth in the numbered Paragraphs below.

Paragraph 1. A method, in particular, computer-implemented method, for calculating an output value of a neural network including multiple neurons (1) as a function of neuron output values (o₁, o₂), including the following steps:
checking (S1, S2) neuron functions of one or of multiple neurons of a neuron group;
when establishing an error in the neuron group, determining (S3) a criticality of the error;
correcting (S5) the neuron output values (o₁, o₂) of at least one of the one or of the multiple neurons (1) of the neuron group as a function of the criticality of an established error.

Paragraph 2. The method as recited in Paragraph 1, wherein the criticality of the error is identified in an error assessment by determining an error with the aid of a check sum comparison, the check sum deviation between the sum of neuron output values (o₁, o₂) and a check sum being assigned to a criticality of the error with the aid of an error assessment function.

Paragraph 3. The method as recited in Paragraph 2, wherein an error is assessed as critical if the check sum deviation is greater than a predefined threshold value.

Paragraph 4. The method as recited in Paragraph 3, wherein the predefined threshold value is established individually or identically for all neuron groups of a layer of neurons or identically for all neuron groups.

Paragraph 5. The method as recited in one of Paragraphs 1 through 4, wherein the criticality of the error is identified in an error assessment by determining an error with the aid of a check sum comparison, the criticality of the established error being determined with the aid of an error assessment function as a function of a check sum deviation between the sum of neuron output values (o₁, o₂) and a check sum, in particular, the error being identified, in particular, as non-critical if the neuron output value is smaller than the check sum deviation.

Paragraph 6. The method as recited in one of Paragraphs 1 through 5, wherein the criticality of errors in an error assessment is determined as a function of the found number of errors of a layer or an area of the neural network.

Paragraph 7. The method as recited in one of Paragraphs 1 through 6, wherein the criticality of an error in an error assessment is determined as a function of the position of the checked neuron group in which an error is established.

Paragraph 8. The method as recited in one of Paragraphs 1 through 7, wherein the criticality of an error is determined with the aid of a data-based, trainable error relevance model, which is trained to specify the criticality of the error as a function of error characteristics, in particular, for different neuron groups of neurons, the check sum deviations and the position of the checked neuron groups within the neural network in which the erroneous calculation has occurred.

Paragraph 9. The method as recited in one of Paragraphs 1 through 8, wherein when establishing a critical error, an error correction is carried out, in which the neuron output values (o₁, o₂) of neurons (1) of the checked neuron group are replaced by an error correction value that corresponds, in particular, to an error-free neuron output value (o₁, o₂).

Paragraph 10. The method as recited in Paragraph 9, wherein when establishing a non-critical error, an error correction is carried out, in which the neuron output values (o₁, o₂) of neurons (1) of the checked neuron group in which an error has been established, is set to zero or are determined, in particular, by interpolation, as a function of neuron output values (o₁, o₂) of adjacent neurons (1), which belong to a neuron group in which no error is established.

Paragraph 11. The method as recited in Paragraph 9, wherein when establishing a non-critical error, an error correction is carried out, in which the error correction values of the neurons of the neuron group identified as erroneous or of one or of multiple neurons determined to be erroneous, are predicted with the aid of a trainable data-based error correction model, which is trained to provide suitable error correction values as a function of neuron output values (o₁, o₂) of adjacent neurons (1).

Paragraph 12. The method as recited in one of Paragraphs 1 through 11, wherein when establishing a non-critical error, no error correction is carried out.

Paragraph 13. A device for calculating an output value of a neural network of multiple neurons (1), the device being designed to carry out the following steps:
checking neuron functions of one or of multiple neurons (1) of a neuron group;
when establishing an error in the neuron group, determining a criticality of the error;
correcting the neuron output values (o₁, o₂) of at least one of the one or of the multiple neurons (1) of the neuron group as a function of the criticality of an established error.

Paragraph 14. A computer program including program code means, which is configured to carry out a method as recited in one of Paragraphs 1 through 12 when the computer program is executed on a processing unit, in particular, on a mobile processing unit.

Paragraph 15. A machine-readable memory medium including a computer program as recited in Paragraph 14 stored thereon.

What is claimed is:

1. A computer-implemented method for calculating an output value of a neural network including multiple neurons as a function of neuron output values, the method comprising the following steps:
checking neuron functions of one or multiple neurons of a neuron group;
when establishing an error in the neuron group, determining a criticality of the error; and
correcting a neuron output value of at least one of the one or multiple neurons of the neuron group as a function of the criticality of an established error.

2. The method as recited in claim 1, wherein the criticality of the error is identified in an error assessment by determining an error using a check sum comparison, a check sum deviation between a sum of neuron output values and a check sum being assigned to a criticality of the error using an error assessment function.

3. The method as recited in claim 2, wherein an error is assessed as critical when the check sum deviation is greater than a predefined threshold value.

4. The method as recited in claim 3, wherein the predefined threshold value is established individually, or identically for all neuron groups of a layer of neurons, or identically for all neuron groups.

5. The method as recited in claim 1, wherein the criticality of the error is determined in an error assessment by determining an error using a check sum comparison, the criticality of the established error is determined using an error assessment function as a function of a check sum deviation between a sum of neuron output values and a check sum, and the error being identified as non-critical when the neuron output value is smaller than the check sum deviation.

6. The method as recited in claim 1, wherein the criticality of the error is determined in an error assessment and is determined as a function of found number of errors of a layer or an area of the neural network.

7. The method as recited in claim 1, wherein the criticality of the error is determined in an error assessment and is determined as a function of a position of a checked neuron group in which the error is established.

8. The method as recited in claim 1, wherein the criticality of the error is determined using a data-based, trainable error relevance model, which is trained to specify the criticality of the error as a function of error characteristics for different neuron groups of neurons, check sum deviations and a position of the checked neuron groups within the neural network in which the erroneous calculation has occurred.

9. The method as recited in claim 1, wherein when the criticality of the error is established, an error correction is carried out, in which neuron output values of neurons of a checked neuron group are replaced by an error correction value that corresponds to an error-free neuron output value.

10. The method as recited in claim 9, wherein when establishing a non-critical error, an error correction is carried out, in which the neuron output values of neurons of the checked neuron group in which the error has been established, is set to zero or are determined by interpolation, as a function of neuron output values of adjacent neurons, which belong to a neuron group in which no error is established.

11. The method as recited in claim 9, wherein when establishing a non-critical error, an error correction is carried out, in which the error correction value of neurons of the neuron group identified as erroneous or of one or multiple neurons determined to be erroneous, are predicted using a trainable data-based error correction model, which is trained to provide suitable error correction values as a function of neuron output values of adjacent neurons.

12. The method as recited in claim 1, wherein when a non-critical error is established, no error correction is carried out.

13. A device for calculating an output value of a neural network of multiple neurons, the device configured to:
checking neuron functions of one or multiple neurons of a neuron group;
when establishing an error in the neuron group, determine a criticality of the error;
correct the neuron output value of at least one of the one or multiple neurons of the neuron group as a function of the criticality of the established error.

14. A non-transitory machine-readable memory medium on which is stored a computer program for calculating an output value of a neural network including multiple neurons as a function of neuron output values, the computer program, when executed by a computer, causing the computer to perform the following steps:
checking neuron functions of one or multiple neurons of a neuron group;
when establishing an error in the neuron group, determining a criticality of the error; and
correcting a neuron output value of at least one of the one or multiple neurons of the neuron group as a function of the criticality of an established error.
